(19) United States
(12) Patent Application Publication
(10) Pub. No.: US 2012/0317323 A1
(43) Pub. Date: Dec. 13, 2012

(54) Processing Interrupt Requests According to a Priority Scheme

(75) Inventors: Markus Koesler, Landshut (DE); Ralph Ledwa, Halblech/Buching Bayern (DE)

(73) Assignee: TEXAS INSTRUMENTS INCORPORATED, Dallas, TX (US)

(21) Appl. No.: 13/473,234

(22) Filed: May 16, 2012

(30) Foreign Application Priority Data
Jun. 9, 2011 (DE) 10 2011 106 103.0

(51) Int. Cl. G06F 13/26

(52) U.S. Cl. 710/264

(57) ABSTRACT

An embodiment of the invention relates to an electronic device for processing interrupt requests. Interrupt requests that have the highest priority level are identified out of a plurality of interrupt requests. A priority word corresponding to a priority level is assigned to each interrupt request. The highest bit level of the bits at the most significant bit position of the priority words is identified. The bit level of the bit at the most significant bit position is compared with the highest bit level at this bit position. The priority words are then evaluated and compared consecutively and bit-by-bit. Priority words having a bit level at the respective bit position that corresponds to the highest bit level are further processed whereas priority words having a different bit level at the respected bit position are discarded.

This application claims priority from German Patent Application No. 10 2011 106 103.0, filed Jun. 9, 2011, which is hereby incorporated by reference for all purposes.

### BACKGROUND

In modern microcontroller systems, it is often required to support several interrupt sources which can interrupt the normal program execution and perform asynchronous exception handling caused by them. This is also true for so-called “systems on a chip” in which many digital functional blocks require a priority decoding of several signals. An example of such a functional block is a nested vectored interrupt controller (NVIC) or a programmable interrupt and event manager (PIEM).

Systems on a chip are for example used in mobiles, embedded computers, smart phones, MP3 players and so on.

If several interrupt sources are present in a system, a priority scheme is needed which defines the order of processing the interrupts arriving at the same time while fast reaction to the interrupt requests has to be ensured.

In order to achieve higher flexibility, programmable priority schemes are used allowing the application program to define the priority level of each interrupt request. Thus, each interrupt request comprises a priority word indicating the priority level assigned to the interrupt source of the interrupt request. A priority word is then composed of a number of bits which depends on the number of interrupt levels required by the system. Each interrupt source may be assigned to a different interrupt level. In this case, the number of supported interrupt sources is equal to the number of interrupt levels. It is also possible to define fewer interrupt levels than interrupt sources, which means that some interrupt sources have the same priority level. The highest binary number corresponds to the highest priority. The number of interrupt levels of a device can be up to 128 corresponding to priority words using seven bits, as 2⁷ is equal to 128.

In order to find the interrupt request, which is to be processed first, the priority words of all active interrupts must be quickly decoded so as to identify the highest valid priority word and thereby the interrupt to be served first.

### SUMMARY

It is an object of the invention to provide an interrupt priority decoder using fewer gates for the same number of interrupt sources, thus requiring less chip area.

It is also an object of the invention to provide an interrupt priority decoder consuming less power and detecting faster the highest priority level of competing interrupt request than prior art decoders.

In one aspect of the invention, an interrupt priority decoder is provided which is configured to identify an interrupt request having the highest priority level out of a plurality of interrupt requests. The interrupt decoder comprises a memory adapted to store for each of the plurality of interrupt requests a priority word corresponding to a priority level. Each priority word may comprise m bits.

The priority decoder may then be configured to identify the highest bit level at the same bit position of the priority words. In other words, if, for example the most significant bit of at least one of the priority words is logic “1”, the highest bit level would be logic “1”. If all the most significant bits are at logic “0”, the highest bit level at this bit position would be logic “0”. The interrupt priority decoder may then be configured to compare the bit levels of the priority words of the respective bit position with the previously identified highest bit level. If the bit level at the respective bit position of a priority word is equal to the highest bit level, the priority word is kept as a potential candidate for the highest priority level and further processed in the subsequent steps. However, if the bit level at the respective bit position of a priority word is different from the highest bit level, the priority word is discarded and not further evaluated or compared during the next steps. This procedure is repeated consecutively and bit-by-bit from the most significant bit to the least significant bit for the remaining priority words (not discarded). The remaining priority words are then the priority words having the highest binary value, and therefore, these priority words are the priority words having the highest priority level.

In an embodiment of the invention, the memory device may comprise flip-flops.

The number m may be any number greater than two depending on the number of interrupt priority levels. If m is, for example 7, there are 128 different interrupt priority levels.

The interrupt priority decoder can comprise an evaluation stage for each bit position of the priority words. The evaluation stage may be adapted to identify the highest bit level at this bit position for all priority words.

The interrupt priority decoder can further comprise a comparison stage for each bit position of the priority words. The comparison stage may be adapted to compare the bit level at the respective bit position with the highest bit level identified in the evaluation stage.

The interrupt priority decoder can then be configured to start evaluation and comparison at the bit position of the most significant bit and to perform evaluation and comparison for the subsequent bit positions only for those priority words for which the preceding comparison revealed a bit level equal to the highest bit level identified at this bit position.

The evaluation in comparison of the priority words may then be started at the bit position of the most significant bit. The evaluation of the bit levels at a specific bit position and the comparison of the bit levels at this bit position with the highest identified bit level may then be performed consecutively and bit-by-bit at the subsequent less significant bit positions.

The evaluation and comparison may then only be performed for the priority words, for which the preceding comparison revealed a bit level equal to the highest bit level at the respective previous bit position.

The priority words, for which the preceding comparison revealed a bit level not equal to the highest bit level at the respective bit position, may then be discarded in the current and all further evaluation and comparison steps.

The at least one remaining priority word is then identified at the at least one priority word having the highest priority level.

In other words, evaluation and comparison is started with the most significant bit. If at least one of the priority words has a logic“1” as the most significant bit, this will be the highest bit level and all priority words having a logic “1” as the most significant bit will be processed further. All priority words having a bit level of logic “0” as the most significant bit will not be processed anymore. Only in the case where all priority words have a logic “1” as the most significant bit or all words have a logic “0” as the most significant bit, all priority words will be passed to the next stage. In the next evaluation stage, the highest bit level at the subsequent bit position will be identified for all priority words, which have been handed over to the next evaluation stage. Again, only those words having the highest identified bit level will be processed further. Due to the decreasing number of priority words being handed over from stage to stage, the power consumption of the priority decoder (or the electronic device comprising the priority decoder) can be substantially reduced. In each of the stages (evaluation and comparison stages) only single bits of each of the priority words are simultaneously compared with each other. This means that the rather complex comparison of complete binary words (for example 7-bit words) is not necessary.

In an embodiment, the interrupt priority decoder comprises an enable input for each of the plurality of interrupt requests and is adapted to process only priority words of active, i.e. enabled interrupt requests. In this context, an active interrupt request is a pending interrupt request or an interrupt request currently being serviced. The priority words of active interrupt requests are referred to as active priority words.

In a further embodiment, the interrupt priority decoder comprises a storage unit adapted to store an intermediate result of at least one of the comparison stages. The storage unit may be realized by a register, but other forms of storage are possible. If no registers/storage units are provided, all bit positions, for example 7, must be processed during one clock cycle, thus limiting the possible clock speed. With a storage unit provided after each comparison stage, only one bit position must be processed during one clock period, allowing for much higher clocks but necessitating as many registers as there are bits in a priority word. Of course, intermediate solutions are possible, for example a register only for each n^{th} bit position, n being greater than 1 and variable within the interrupt priority decoder.

In an embodiment the evaluation stages comprise OR gates and the comparison stages comprise AND gates.

In an embodiment, an electronic device, for example a system-on-chip is provided, comprising an interrupt priority decoder according to the invention and a microcontroller which receives the interrupt requests according to their priority. The priority words may then be programmable by an application program running on the microcontroller.

In an embodiment, an electronic device may comprise an additional hard-coded priority decoder. The hard-coded priority decoder may then be configured to provide a fixed priority scheme for prioritizing multiple interrupt requests having the same, and in particular the highest priority level.

The hard-coded priority decoder may then be coupled to an output of the comparison stage of the least significant bit. The hard-coded priority decoder is required, if, for example, a plurality of interrupt sources is assigned to the same priority level. Within the hard-coded priority decoder, the interrupt requests are in a fixed priority order. The interrupt request having the highest hard-coded priority is then serviced first. The remaining active interrupt requests are suppressed until the interrupt having a higher priority are serviced. Servicing the interrupt requests is then performed like in a chain.

The invention further provides a method for identifying an interrupt request or interrupt requests having the highest priority level out of a plurality of interrupt requests. Priority words indicating the priority level are assigned to the interrupt requests. Each of the priority words may then have m bits. The highest bit level of the most significant bits of the priority words is then identified. For all priority words, the bit levels of the bits at the most significant bits position are compared with the highest bit level that has previously been identified at the most significant bit position. The following steps are only performed for priority words for which the preceding comparison step has revealed bit level equal to the highest bit level. These steps are performed consecutively and bit-by-bit from the most significant bit to the least significant bit.

Accordingly, the highest bit level at a subsequent bit position (having less significance) is identified for all remaining priority words. The bit level of the bit at the respective bit position is then compared with the highest bit level at the respective bit position. This procedure is repeated bit-by-bit until the bit position of the least significant bit is reached. Alternatively, the procedure of eliminating priority words may be stopped if only a single priority word remains. The remaining priority word or the remaining priority words are then the priority words having the highest priority level.

In an embodiment, the method may comprise a preceding step of programming the priority levels by an application program.

### BRIEF DESCRIPTION OF DRAWINGS

Further details and characteristics of the invention will ensue from the following description of the embodiments of the invention with reference to the accompanying drawings, wherein:

FIG. 1 shows a binary tree used for identifying the highest priority (Prior Art):

FIG. 2 is a simplified diagram illustrating the operation of the interrupt priority decoder according to an embodiment of the invention;

FIG. 3 is a simplified schematic of the interrupt priority decoder according to an embodiment of the invention;

FIG. 4 and FIG. 5 are simplified and schematic diagrams of an interrupt priority decoder comprising storage units according to an embodiment of the invention;

FIG. 6 is a simplified diagram of an electronic device comprising an interrupt priority decoder, a hard-coded decoder and a microcontroller according to an embodiment of the invention;

FIG. 7 shows a table in which gate counts and processing times of an embodiment of the invention are compared with an example embodiment according to the prior art, and

FIG. 8 is a table comparing the power consumption of an embodiment of the invention with the power consumption of a prior art decoder using a binary tree.

### DETAILED DESCRIPTION OF AN EXAMPLE EMBODIMENT

FIG. 2 is a simplified diagram illustrating the procedure of identifying the interrupt request having the highest priority according to an embodiment of the invention. There are three priority words, each of which has three bits. There are three interrupt requests IRQ5, IRQ8 and IRQ12. A first interrupt request IRQ5 relates to a 5^{th} interrupt source having a priority value of 5 corresponding to 101 in binary form. A second interrupt request IRQ8 relates to an 8^{th} interrupt source has a priority value of 4 corresponding to 100 in binary form. A third interrupt request IRQ12 relates to a 12^{th} interrupt source having a priority value of 3 corresponding to 011 in binary form. The priority words “101”, “100” and “011” are stored in a memory of the interrupt priority decoder according to this embodiment of the invention.

In a first stage 24, the most significant bits of all three binary words, i.e. 1, 1 and 0, and compassed by dashed line 26 are processed in an evaluation stage for identifying the highest bit level at this bit position. The current bit position is the bit position of the most significant bit (MSB). The highest bit level at this bit position is logic “1”.

The highest bit level of logic “1” that has been identified in the evaluation stage will then be compared with the bit levels of the most significant bits of the three priority words. The priority words IRQ5 and IRQ8 also have a bit value of logic “1” at the most significant bit position. The priority word of IRQ12 has a logic “0” at the most significant bit position. Therefore, only the priority words of interrupt requests IRQ5 and IRQ8 are further processed as indicated in stage 28. This is indicated by the dashed line 30 around the two middle bits of the priority words of IRQ5 and IRQ8 and the priority word of IRQ12 being crossed out. As the priority words of IRQ5 and IRQ8 both have a logic “0” at the second bit position, the logic “0” is the highest bit level at this bit position.

Since priority words have the same bit level as the highest bit level of this bit position, both priority words (the priority words of IRQ5 and IRQ8) are further processed in stage 32. The evaluation stage of stage 32 is configured to identify the highest bit level of the two bits of the priority words of IRQ5 and IRQ8 at the least significant bit position. The bit value or bit level at the least significant bit position is logic “1” for IRQ5 and logic “0” for IRQ8. Therefore, the highest bit level at this bit position is logic “1”. In the comparison stage of stage 32, the bit levels at the least significant bit position of the priority words of IRQ5 and IRQ8 are compared with the highest identified bit level at this bit position (logic “1”). As only the priority word of IRQ5 has the same bit level, the priority word of the interrupt request IRQ5 is the only remaining priority word (winner) and therefore identified as the priority word having the highest priority level.

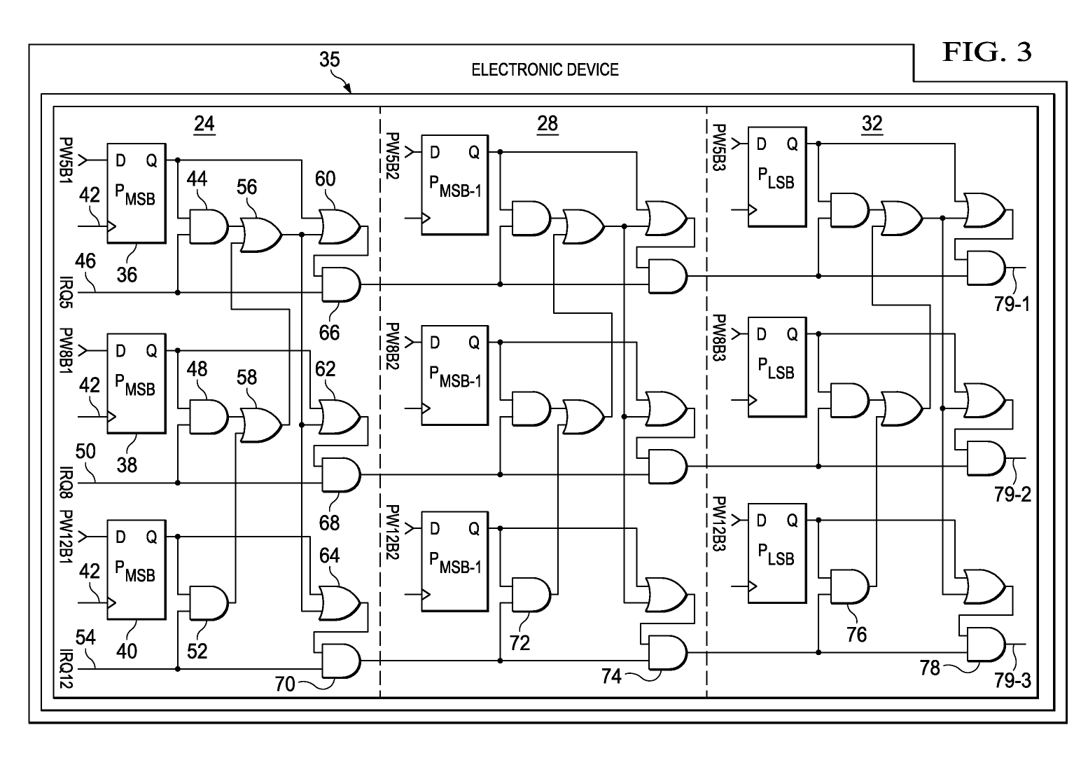

The priority word having the highest priority level is also the priority word having the highest binary value. FIG. 3 shows a programmable interrupt priority decoder 35 according to an embodiment of the invention. Generally, an interrupt priority decoder 35 according to the invention may comprise adequate circuitry for processing as many interrupt requests and corresponding priority words as there are interrupt sources which have to be supported. The interrupt priority decoder 35 according to aspects of the invention also comprises as many subsequent stages as there are bits in the priority words. The priority decoder 35 of this embodiment of the invention is configured to process active interrupt requests in three stages supporting priority words having three bit. The same circuitry as for IRQ5, IRQ8 and IRQ12 is implemented for other, inactive interrupts. The illustrative example explained with respect to FIG. 2 will also be used for explaining the operation of the circuitry shown in FIG. 3. Accordingly, the priority words of interrupt requests IRQ5, IRQ8 and IRQ12 are “101”, “100” and “011”, respectively.

There is a first stage 24, for evaluation and comparison of the most significant bit, a second stage 28 for evaluation and comparison of the subsequent bit position and a third stage 32 for evaluation and comparison of the least significant bit are provided. As the gates and the interconnections of the gates are identical in stages 24, 28 and 32, only the first stage 24 will be explained in detail.

Stage 24 comprises a memory device for which three D flip-flops 36, 38 and 40 are shown, as there are only three active interrupts. In general, there are as many D flip-flops as there are interrupt sources. Each D flip-flop 36, 38 and 40 comprises an input D, a clock input 42 and a data output Q. D flip-flops 36, 38 and 40 are provided for storing the most significant bit PW5B1, PW8B1, PW12B1 of the respective priority words of IRQ5, IRQ8 and IRQ12. In the subsequent stage 28, the D flip-flops are provided for storing the second bits PW5B2, PW8B2, PW12B2, whereas in the last stage 32, the D flip-flops are provided for storing the least significant bits PW5B3, PW8B3 and PW12B3. Accordingly, the priority words for IRQ5, IRQ8 and IRQ12 are “PW5B1, PW5B2, PW5B3”, “PW8B1, PW8B2, PW8B3”, and “PW12B1, PW12B2, PW12B3”, respectively. As known to the person skilled in the art, to store a bit, data input D is used. For example, in an initialization phase, an application program running on a microprocessor may store the priority words designating the priority levels of the respective interrupt sources into the D flip-flops.

Stage 24 further comprises an AND gate 44 with an input connected to the output Q of D flip-flop 36 and a second input connected to an enable line 46 related to interrupt request IRQ5. Stage 24 further comprises an AND gate 48 with an input connected to the output Q of D flip-flop 38 and a second input connected to an enable line 50 related to interrupt request IRQ8. Stage 24 further comprises an AND gate 52 connected with one input to data output Q of D flip-flop 40 and a second input connected to an enable line 54 related to interrupt request IRQ12.

Stage 24 further comprises a NOR gate 56 and an OR gate 58. NOR gate 56 is connected with one input to an output of AND gate 44 and with a second input to an output of OR gate 58. OR gate 58 is connected with one input to an output of AND gate 48 and with a second input to an output of AND gate 52.

Stage 24 further comprises an OR gate 60, an OR gate 62 and an OR gate 64. OR gate 60 is connected with one input to the data output Q of D flip-flop 36, and with a second input to an input of OR gate 62 and an input of OR gate 64. OR gate 62 is connected with one input to the data output Q of D flip-flop 38 and with the other input to an input of OR gate 60 and an input of OR gate 64. OR gate 64 is connected with the second input to data output Q of D flip-flop 40.

Stage 24 further comprises an AND gate 66, an AND gate 68, and an AND gate 70. AND gate 66 is connected with one input to the output of OR gate 60 and with its other input to the enable line 46 of IRQ5. AND gate 68 is connected with one input to an output of OR gate 62 and with a second input to the enable line 50 of IRQ8. AND gate 70 is connected with one input to the output of OR gate 64 and with the other input to the enable line 54 of IRQ12. The output of AND gate 66 is connected to the second stage 28 in a similar manner as enable line 46 of IRQ5 to stage 24. The output of AND gate 68 is connected to the second stage 28 in a similar manner as enable line 50 of IRQ8 to stage 24. AND gate 70 is connected with its output to the second stage 28 in a similar manner as enable line 54 of IRQ12 to stage 24.

In operation, an active interrupt request sets an enable bit to logic “1” on enable lines 46, 50, 54, respectively. In the present example IRQ5, IRQ8 and IRQ12 are considered to be active interrupt requests so that on AND gates 66, 68 and 70 the input connected to the enable lines receives a logic “1”. Thus, if on the other input of the AND gates 66, 68 or 70, there is also a logic “1”, the AND gates provide a logic“1” and their outputs, such that the next stage 28 is enabled.

As mentioned above, in FIG. 3 only the circuitry associated to the active interrupts is shown. However, all interrupt sources are connected with a respective enable line to the interrupt priority decoder and all priority words of all interrupt sources are stored in respective D flip-flops. The inactive interrupt requests set their respective enable lines to logic “0”, thus, none of the stages is enabled.

AND gates 44, 48 and 52 are also coupled to the enable lines 46, 50 and 54 respectively, so that they have a logic “1” at one of their inputs. The other input receives the respective most significant bit. Thus, if the most significant bit is a logic “1”, AND gates 44, 48 and 52 will output a logic “1”, and if the most significant bit is a logic “0”, AND gates 44, 48 and 52 will output a logic “0”, respectively. In other words, AND gates 44, 48 and 52 output the respective most significant bit.

In the present example, i.e. with the priority words shown in FIG. 2, AND gates 44 and 48 output a logic “1”, whereas AND gate 52 outputs a logic “0”. The most significant bits of IRQ8 and IRQ12, i.e. the outputs of AND gates 48 and 52 are ORed together in OR gate 58. If only one of the two input signals to OR gate 58 is logic “1”, OR gate 58 will outputs a logic “1”, otherwise a logic “0”. In the present case, OR gate 58 outputs a logic “1”.

The highest bit level of the most significant bits of IRQ8 and IRQ12 is fed to NOR gate 56 which receives at its other input the most significant bit of IRQ5.

NOR gate 56 outputs a logic “0” if only one of the two inputs is logic “1” and otherwise NOR gate 56 outputs a logic “1”. In the present example, NOR gate 56 will output a logic “0” as both inputs are logic “1”.

OR gate 58 and NOR gate 56 form an evaluation stage adapted to identify the highest bit level at the bit position for all priority words. The evaluation stage may be extended to accept more priority words.

OR gates 60, 62 and 64 “compare” the respective most significant bit of the different priority words IRQ5, IRQ8 and IRQ12, which are output at data outputs Q, with the output of NOR gate 56, i.e. with the highest bit level at the most significant bit position of all priority words. In the present example the highest bit level is logic “1”, so NOR gate 56 outputs a logic “0”. As the most significant bit for IRQ5 is a logic “1”, OR gate 60 outputs a logic “1”. This is also the case for IRQ8 at OR gate 62. The most significant bit of the priority word of IRQ12 is logic “0”. Therefore, OR gate 64 outputs a logic “0”.

OR gates 60, 62 and 64 form the comparison stage which is adapted to compare for each priority word the bit level at the respective bit position (i.e. for stage 24 the bit position of the most significant bit) with the highest bit level identified in the evaluation stage. Of course, the comparison stage may be extended to accept more priority words.

AND gates 66 and 68 receive at both inputs a “1” and output a logic “1” thereby enabling further processing of IRQ5 and IRQ8. AND gate 70 receives a logic “0” and a logic “1” at its inputs and will output a logic “0”, thereby deactivating further processing of IRQ12.

Therefore, evaluation and comparison for the subsequent bit positions will only be done for those priority words for which the precedent comparison revealed a bit level equal to the highest bit level identified for the most significant bit.

Due to the deactivating logic “0”, the following AND gates 72 and 74 in stage 28 and AND gates 76 and 78 in stage 32 will receive a logic “0” at one of their inputs. These AND gates will not toggle any more and therefore not consume power. This reduces the overall power consumption.

When, to the contrary, all most significant bits were logic “0”, AND gates 44, 48 and 52 would output a logic “0”. Thus, OR gate 58 would output a logic “0” as well and NOR gate 56 would output a logic “1” to which the most significant bits, i.e. logic “0”, would be compared in OR gates 60, 62 and 64. Receiving a logic “1” and a logic “0” at their respective inputs, OR gates 60, 62 and 64 would also output a logic “1” as in the case of a most significant bit logic “1”. Therefore, AND gates 66, 68 and 70 would output a logic “1” and enable further processing of all three interrupt requests as all three priority words have the same bit level as the highest bit level of the most significant bits.

Stages 28 and 32 operate similar to stage 24. Therefore, only those priority words having the same bit level as the highest bit level at the bit position which is compared and evaluated in the respective stage are further processed.

In the last stage, i.e. in stage 32, the least significant bit of the priority words is evaluated and compared. As the priority word of IRQ5 has the highest priority value (the highest binary value), only output 79-1 is at logic “1”. This indicates that IRQ5 is the interrupt request having the highest priority level. The outputs 79-2, and 79-3 are at logic “0”.

FIG. 3 shows an example for a priority word with three bits only. The inventive interrupt priority decoder and the inventive method are especially advantageous if a higher number of interrupt requests is to be supported, for example 128. In this case, a priority word having 7 bit positions is required and it is to be understood that in this case 7 stages are necessary, one for each bit position. Each stage always comprises an evaluation stage in which the highest bit level for this bit position is evaluated and a comparison stage in which each priority word is compared to this highest bit level.

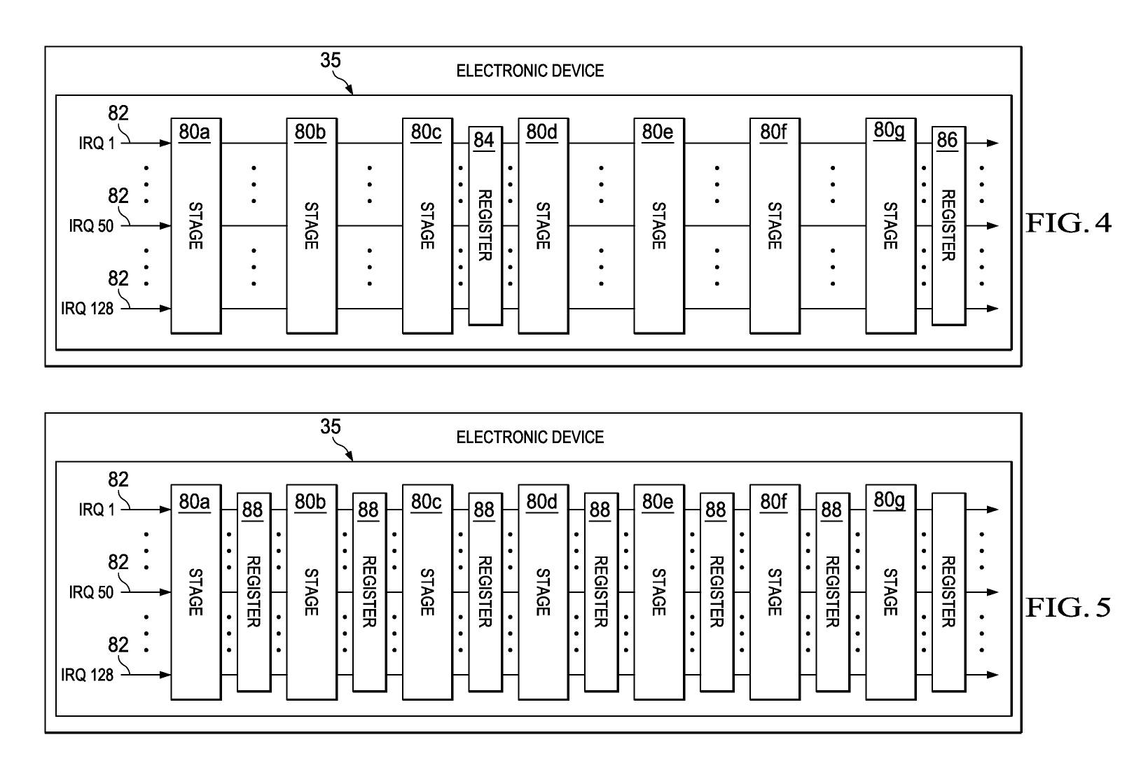

With a higher number of stages the number of gates to be passed for decoding the highest priority word increases. Depending on the clock used, the signal delay caused by the subsequent gates may be greater than a clock cycle. Thus, for fast clocks it may be necessary to provide storage units to store intermediate results. FIG. 4 is a simplified diagram of an interrupt priority decoder 35 according to an embodiment of the invention. The priority decoder 35 comprises seven stages 80a to 80g for decoding 7-bit priority words. Each stage 80a to 80g comprises circuitry as explained with reference to FIG. 3 for stage 24. In the example, 128 enable lines 82 of 128 interrupt sources to be supported are coupled to stage 80a in which the most significant bits are compared. Thus, stage 80a comprises 128 D flip-flops. Three exemplary enable lines 82 for interrupt sources IRQ1, IRQ50 and IRQ128 are shown. Dots between the enable lines visualize that there are further enable lines.

To allow for a higher clock rate, a register 84 for storing an intermediate result is provided after stage 80c and a register 86 is provided after stage 80g. Thus, during a first clock cycle, the first three bits of the priority words are evaluated and compared, and during a second clock cycle, the last four bits of the priority words are evaluated and compared.

FIG. 5 is very similar to FIG. 4 with the difference that registers 88 are provided after each stage 80a to 80g. Thus, a very fast clock is possible, only one bit is to be evaluated and compared during one clock cycle.

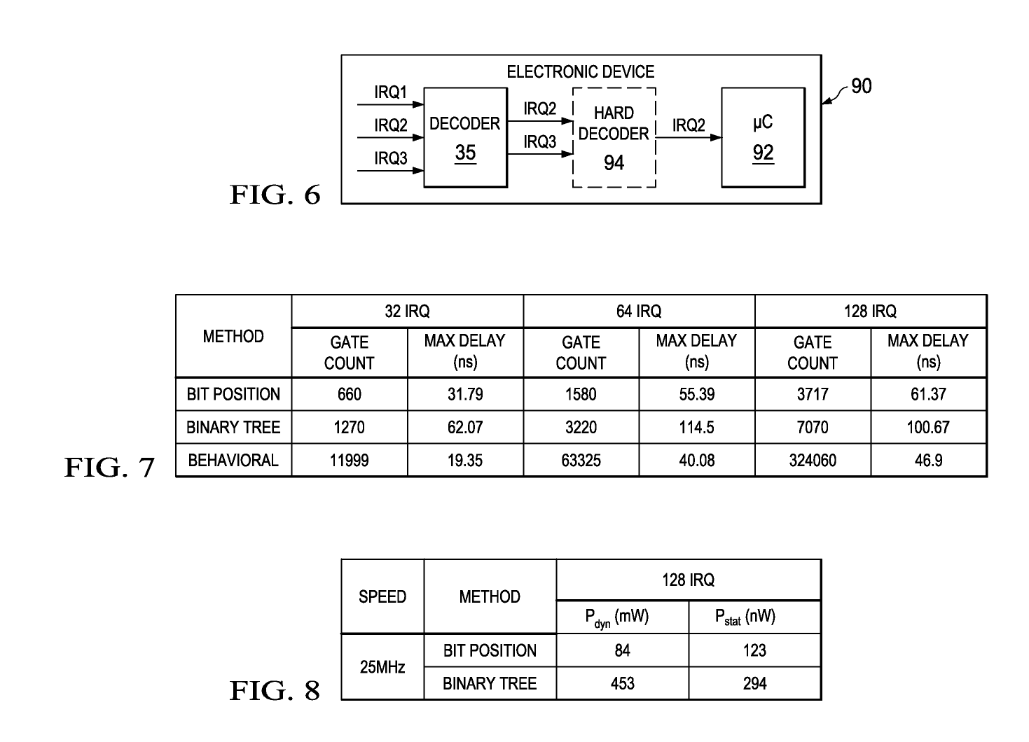

FIG. 6 is a simplified diagram of an electronic device 90 according to an embodiment of the invention. The electronic device 90 comprises an interrupt priority decoder 35 and a microcontroller 92.

Interrupt priority decoder 35 is coupled to all supported interrupt sources. Active interrupt requests set an enable line at the interrupt priority decoder 35 to “enabled”. In the present example, only active interrupt requests IRQ1 to IRQ3 are shown, which are received at the same time as indicated by the arrows. As already explained, programmable interrupt priority decoder 35 comprises a memory device for example in the form of D flip-flops for storing all bits of all priority words assigned to the different interrupt sources supported.

An application program running on microcontroller 92 assign different priority levels to all interrupt sources, each priority word corresponding to a priority level. The priority words are stored in the memory device of decoder 35. Another application program may assign other priority levels to the interrupt sources and thus store other bits in the D flip-flops. The interrupt priority decoder 35 is programmable and the priority levels can be adapted to the application program. Programming may also be separately effectuated and not by the application program.

The electronic device may optionally further comprise a hard-coded decoder 94. FIG. 6 shows a simplified diagram of an embodiment of the invention. The hard-coded decoder 94 is indicated by a dashed line. All interrupt sources are assigned a fixed unique priority level, i.e. all interrupt sources are ranged in a list. The hard-coded decoder 94 may be necessary, if for example the same priority level and thus the same priority word is assigned to more than one interrupt source. In this case, the inventive programmable interrupt priority decoder 35 cannot identify a single highest priority word, as there are two or more highest priority words. As the microcontroller 92 cannot handle more than one priority word at a time, hard-coded priority decoder 94 would then assign priorities to the interrupt requests according to a fixed list.

In the example shown in FIG. 6, the hard coded priority scheme provides that IRQ1 has a higher priority than IRQ2 has a higher priority than IRQ3. In the example shown in FIG. 6, the programmable priority decoder according to aspects of the invention issues IRQ2 and IRQ3 as two interrupt requests having the same priority. Therefore, these two interrupt requests IRQ2, IRQ3 are fed to the hard-coded priority decoder to be further processed. Interrupt requests IRQ2 and IRQ3 have the same highest priority words. Hard-coded priority decoder 94 decides that IRQ2 has the higher priority and has to be transmitted to microcontroller 92. The electronic device shown in FIG. 6 may be an integrated circuit, for example a system on a chip.

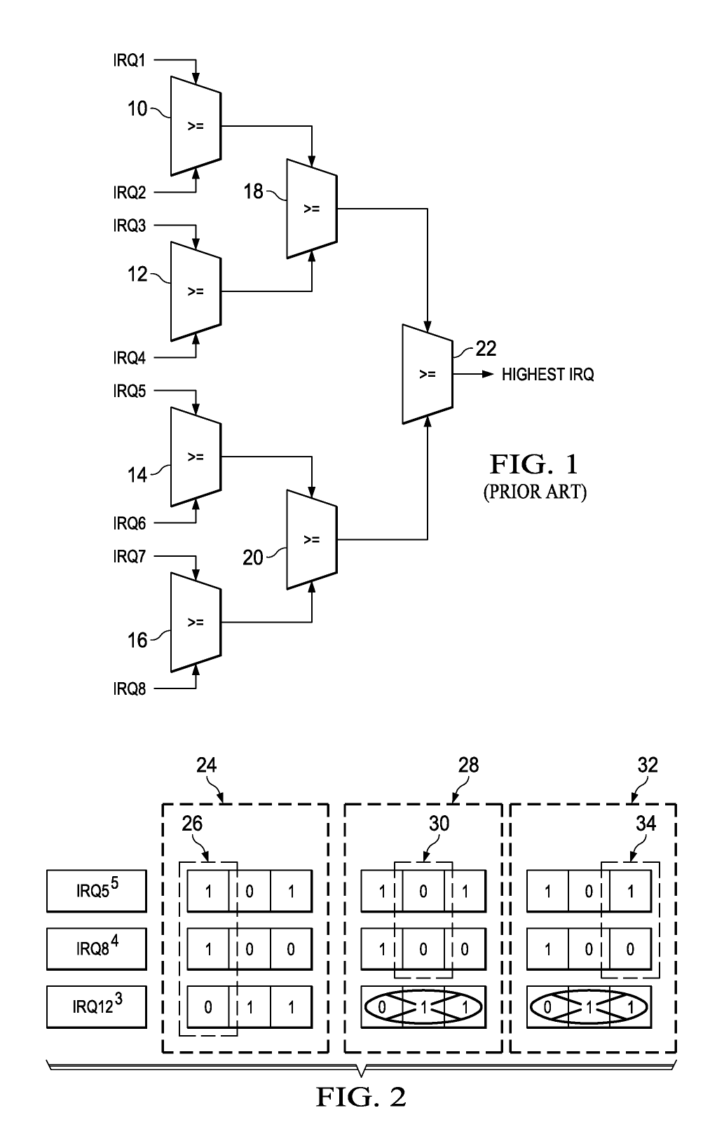

FIG. 7 shows in a table a comparison between the inventive method referred to as “bit position” and a method referred to as “binary tree” as explained with respect to FIG. 1. The method according to the invention is also compared with a method referred to as “behavioral”. This “behavioral” method requires a complete comparison of all priority words with each other. “Behavioral” decoding is synonymous to “bubble sorting” as described hereinabove.

The first two columns compare the three methods with each other in the case of 32 interrupt requests supported. The next pair of columns compares the three methods in the case of 64 interrupt requests supported and the last two columns compare the methods in the case of 128 interrupt requests supported. In all three cases the inventive method requires only about half the gates necessary for the binary tree approach. A smaller gate count implies a smaller area required on the chip and thus reduced costs.

The inventive method is also much faster than the binary tree approach, although it is somewhat slower than the behavioral method which requires on the other hand a much higher number of gates.

FIG. 8 shows in another table the comparison between the inventive method “bit position” and the “binary tree” approach for 128 interrupt requests supported in terms of power needed. The inventive method needs only about 20% of the dynamic power necessary for the binary tree approach. This is essentially due to the fact that only those priority words continue to be processed which have the highest bit level. The difference in the static power is less important, as the static power compared to the dynamic power is anyhow only a thousandth.

Although the invention has been described hereinabove with reference to a specific embodiments, it is not limited to these embodiments and no doubt further alternatives will occur to the skilled person that lie within the scope of the invention as claimed.

1. A programmable interrupt priority decoder for identifying an interrupt request having the highest priority level out of a plurality of interrupt requests, the decoder comprising
a memory adapted to store for each of the plurality of interrupt requests a priority word corresponding to a priority level, each priority word comprising m bits, the interrupt priority decoder further comprising
for each bit position of the priority words
an evaluation stage adapted to identify the highest bit level at the respective bit position for the priority words; and
a comparison stage adapted to compare the bit level at the respective bit position with the highest bit level identified in the evaluation stage, wherein
the interrupt priority decoder is further adapted
to start evaluation and comparison of the priority words at the bit position of the most significant bit and to perform evaluation and comparison consecutively and bit-by-bit at the subsequent less significant bit positions only for the priority words for which the preceding comparison revealed a bit level equal to the highest bit level at the respective previous bit position while discarding priority words in the current and all subsequent evaluation and comparison steps for which the preceding comparison revealed a bit level not equal to the highest bit level at the respective previous bit position, and to identify thereby the at least one remaining priority word as the at least one priority word having the highest priority level.

2. The interrupt priority decoder according to claim 1, further comprising an enable input for each of the plurality of interrupt requests and adapted to process only priority words of active, i.e. enabled interrupt requests.

3. The interrupt decoder according to claim 2, further comprising a storage unit adapted to store an intermediate result of at least one of the comparison stages.

4. An electronic device comprising an interrupt priority decoder according to any of the preceding claims further comprising a hard-coded decoder comprising a fixed priority scheme for prioritizing multiple interrupt requests having the highest priority level.

5. The electronic device of claim 4, further comprising a microcontroller receiving the interrupt requests according to their priority, wherein the priority words are programmable by an application program running on the microcontroller.

6. The electronic device according to claim 5, being realized on an integrated circuit as a system on a chip.

7. A method for identifying an interrupt request or interrupt requests having the highest priority level out of a plurality of interrupt requests, wherein a priority word corresponding to a priority level is assigned to each interrupt request and each of the priority words has m bits, the method comprising the steps of
a) identifying the highest bit level of the bits at the most significant bit position of the priority words;
b) comparing for each priority word the bit level of the bit at the most significant bit position with the highest bit level which being identified in step a);
c) performing the following steps consecutively bit-by-bit only for priority words for which the preceding comparison step has revealed a bit level equal to the highest bit level;
d) identifying the highest bit level at a subsequent bit position having less significance for all priority words selected according to step c);
e) comparing for each priority word selected according to step c) the bit level of the bit at the bit position selected in step d) with the highest bit level identified in step d);
f) repeating steps c) to e) until the bit position of the least significant bit is reached and/or only one priority word remains, and
identifying the remaining priority word or the priority words as the priority word or words having the highest priority level.

8. The method of claim 7, wherein only priority words of active interrupt requests are processed.

9. The method of claim 8, further comprising a preceding step of programming the priority levels, i.e. the priority words by an application program.
